(19) United States
(12) Patent Application Publication
(10) Pub. No.: US 2001/0043532 A1
(43) Pub. Date: Nov. 22, 2001

(54) Optical disc apparatus

(76) Inventors: Hiroyuki Tsuchinaga, Kodaira (JP); Toshimitsu Kaku, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/846,219

(22) Filed: May 2, 2001

(30) Foreign Application Priority Data
May 10, 2000 (JP) 2000-142301

(51) Int. Cl. G11B 7/00

(52) U.S. Cl. 369/53.19; 369/53.34; 369/124.14

(57) ABSTRACT

An optical disc apparatus prevents erroneous compensation of tilt and minimizes distortion of waveform of the optical and electrical transmitter channel as a whole. For this purpose, a group delay compensator that assures flat frequency characteristic of the gain and can adjust frequency characteristic of group delay is provided to the electrical transmitter of the optical disc apparatus including tilt controller and settings of tilt and group delay are optimized, in the adjustment, to provide minimum jitter of the reproduced signal or minimum code error of data obtained from the reproduced signal.

### BACKGROUND OF THE INVENTION

The present invention relates to an optical disc apparatus for obtaining a reproduced signal by irradiating an optical disc with an optical spot and particularly to an optical disc apparatus including a means for preventing quality deterioration of the reproduced signal and a method and an apparatus for adjusting the optical disc apparatus.

In an optical disc apparatus, an optical head consisting of a light source, an optical detector and an objective lens or the like, radiates an optical beam condensed to an optical spot to an optical disc and a reproduced signal can be extracted from the reflected beam. In this case, it is a known fact that when a relative inclination (hereinafter referred to as “tilt”) is generated between a disc and the axis of optical beam, namely when the axis of optical beam is deviated from the right angle for the surface of disc, quality of reproduced signal of optical disc is deteriorated and jitter increases {For example, “Kogaku (Japanese Journal of Optics)” published by the Optical Society of Japan (An affiliate of the Japan Society of Applied Physics), vol. 12, No. 6, pp. 437-443 (December, 1983)}. Here, tilt can be classified into a tilt in the direction of information tracks, namely in the radial direction and a tilt in the direction of information track, namely in the tangential direction. The former generates crosstalk phenomenon in which the signal from information pit recorded in the adjacent tracks leaks in, while the latter generates inter-symbol interference due to the leak of signal from the adjacent recording pit of the same track. This inter-symbol interference changes its extent depending on a pattern of the recording pit and therefore results in jitter.

The latter, namely the tilt in the tangential direction will further be explained with reference to FIGS. 9(a) and 9(b). FIGS. 9(a), 9(b) illustrate relationship between a power profile of the optical spot and recording pit on the disc surface. FIG. 9(a) corresponds to no tilt in the optical axis, wherein the optical spot has the main robe M in the shape of Gaussian distribution in which the cross-section being cut in the track direction is symmetrical in the right and left sides for the peak. On the other hand, FIG. 9(b) corresponds to existence of tilt in the optical axis wherein side robe S is generated depending on the direction of tilt for the main robe M. When it is assumed that the optical spot is scanning in the direction indicated by an arrow mark for the pits a, b, c on the disc, if the optical axis is not tilted, the optical spot Ms by the main robe M irradiates only the pit b, but if the optical axis is tilted, the optical spot Ss by the side robe S irradiates the adjacent pit c and therefore the signal resulting from the pit c leaks to generate inter-symbol interference.

The optical spot having the power profile as illustrated in FIG. 9(b) is accompanied with coma. The space frequency characteristic of a transfer function of the optical spot in case the scanning is performed with the optical spot having coma results in more reduction of amplitude and larger lag of phase when the frequency is higher (refer to the reference cited above). Waveform of reproduced signal depending on such characteristic has distortion similar to the waveform that is shown when there is distortion of phase characteristic in an electric circuit.

In regard to a problem of tilt, the inventors of the present invention have disclosed a method for effectively removing distortion of waveform of a reproduced signal generated with coma in the Japanese Patent Laid-open (Kokai) No. Hei 7-50027. In this method, a waveform equalizer formed of a tapped transversal filter and an adjusting mechanism that can mechanically vary a tilt are used to roughly adjust the tilt with the adjusting mechanism so that the preceding and successive tap coefficients are almost equalized and finally a residual error which cannot be adjusted will be removed through fine adjustment of the tap coefficient.

Here, the linearity of phase characteristic in the transmission channel when a signal detected with an optical head passes the transmitter will briefly be explained below. A frequency characteristic of transmitter is expressed with the following transfer function.

H(f)=|H(f)|exp(j2πf·Φ(f))

Here, f is frequency and j is imaginary number. |H(f)| is frequency characteristic of gain, Φ (f) is frequency characteristic of phase. Particularly, the amount expressed with time obtained by differentiating the phase Φ (f) with angular frequency 2πf, namely a group delay indicates lag and lead of the transmission time of each frequency element obtained by executing the Fourier transformation to the signal passing the transmitter. When the frequency characteristic of the group delay is constant, it means that the waveform of transmission signal does not change. The group delay becomes constant when Φ (f) does not depend on the frequency or it is expressed with the linear function of f, namely when the linearity of phase characteristic can be obtained.

In the transmitter where the linearity of phase characteristic cannot be obtained, lag or lead is generated in the group delay characteristic and distortion of waveform is generated depending on lag and lead of such group delay characteristic. This distortion of waveform resembles in the case where uni-directional inter-symbol interface is generated with a tilt as explained above.

Practical influence on the transmission waveform by a group delay in the transmitter will be illustrated in FIGS. 8(a) , 8(b) , 8(c). These figures indicate distortions of the reproduced signal waveforms when a group delay proportional to the frequency is given in regard to the repeated patterns of pits and spaces in the 9T, 11T, 13T lengths for the reproduction in the time unit T of 17 nsec. These figures correspond to the signal waveforms when the group delay per 1 MHz is set to +1.7 ns, 0 ns, −1.7 ns. The waveform of FIG. 8(b) where there is no group delay is almost symmetrical in the former and latter portions, but the signal level of the trailing edge portion rises in FIG. 8(a) and that of the leading edge portion rises in FIG. 8(c) and therefore these waveforms cannot be said as the symmetrical waveform. Change of these waveform is similar to the distortion of waveform due to the coma as explained above.

An ordinary structure of the transmitter of the optical disc reproducing channel comprises a photo-diode (photo-detector) to convert change of optical amount into a current signal by receiving the optical beam reflected from a disc, a current-voltage amplifier for converting a current signal of the photo-diode to a voltage signal, a reproducing circuit having the function to reproduce data using the voltage signal from the current-voltage amplifier, and a flexible printed cable for transmitting the signal among these structural elements.

### SUMMARY OF THE INVENTION

The photo-diode and current-voltage amplifier are essentially important structural elements to determine the quality of detected signal. In view of faithfully converting the high-speed modulated optical detection signal to a high-speed electrical signal without reduction of gain, a current-voltage amplifier formed of a differential operational amplifier (OP amplifier) is usually used. In this structure, wide-band signal can be obtained rather easily, on the other hand, the frequency characteristic of gain tends to have the peak in the high frequency band.

As a result that the phase characteristic is deviated from the linearity of phase characteristic because of generation of such peak value, the group delay becomes to have the frequency characteristic. Therefore, the lag/lead characteristic of each frequency element included in the detected signal is different and thereby distortion of waveform is generated.

Moreover, with improvement in the speed of signal, influence of phase characteristic is not negligible even in the reproducing circuit. In the reproducing circuit, a waveform equalizer is used to remove the inter-symbol interference included in the detected signal by positively changing the frequency characteristic of gain in the detected signal and to improve the performance of data reproducing. The waveform equalizer can be designed in principle in such a manner that the phase characteristic becomes equal to the linearity of phase characteristic but when the frequency becomes high, fluctuation of circuit constants of resistor, capacitor or the like cannot be neglected and thereby it is inevitable that the phase characteristic is deviated from the linearity of phase characteristic.

In regard to the flexible printed cable, it has the inductance, capacitance and resistance elements and an influence of these elements cannot be negligible.

When a series of processes that a disc is irradiated with the optical spot, a signal is reproduced from the reflected light beam and the reproduced signal is inputted to an electrical circuit for necessary process is defined as the optical and electrical transmission channel of the optical disc apparatus, distortion of waveform mainly due to the optically generated coma in the tangential direction and distortion of waveform mainly due to the intrinsic group delay characteristic of the transmission channel of the electric circuit exist in the optical/electrical transmission channel as explained above. Therefore, in the conventional tilt adjustment, there is a fear for erroneously compensation for the tilt by considering the distortion of waveform caused by the group delay characteristic in the transmission channel of the electric circuit as the distortion resulting from the coma.

If erroneous compensation is conducted, the side robe of optical spot increases to cancel distortion of waveform in the transmission channel and the main robe is then reduced as much as increase of the side robe. Therefore, jitter increases with the result that amplitude of detected signal becomes lower and therefore a signal-to-noise ratio is reduced. Such problem is not negligible as more improvement in recording density, data capacity and high speed transfer of data in the optical disc is realized.

It is therefore an object of the present invention to provide an optical disc apparatus, a method and apparatus for adjusting the optical disc apparatus, that can prevent erroneous compensation of tilt and minimize distortion of waveform of the total optical and electrical transmission channel.

The problems of the present invention explained above can effectively be solved by providing a group delay compensator for providing the flat frequency characteristic of gain and adjusting the frequency characteristic of group delay in the transmitter of the electric circuit of the optical disc apparatus including the tilt adjusting mechanism in view of optimizing the setting of the tilt and group delay to minimize the jitter of the reproduced signal or code error of data obtained from the reproducing circuit. In any case of minimizing jitter or error, setting of tilt and group delay can be optimized but in the case, for example, where an error of the reproduced data is minimized, in more practical, a tilt providing the minimal error is obtained by adjusting the tilt while the group delay is set to a certain value. In turn, a group delay providing the minimal error is obtained by adjusting the group delay under such condition. Moreover, the tilt is adjusted again under the same condition. When the tilt and group delay that can no longer reduce the error are obtained by repeating above processes, such values assure the setting of optimum tilt and group delay.

With the adjustment explained above, distortion of waveform in the total optical and electrical transmitter can be minimized.

These and other objects and many of the attendant advantages of the invention will be readily appreciated as the same becomes better understood by reference to the following detailed description when considered in connection with the accompanying drawings.

### BREIF DESCRIPTION OF THE DRAWINGS

FIG. 1 is a structural diagram for explaining a preferred embodiment of an optical disc apparatus and adjusting method of the present invention.

FIG. 2 is a circuit diagram for explaining a group delay compensator used in the embodiment of FIG. 1.

FIG. 3 is a graph for explaining a compensation example of the group delay characteristic of the current-voltage amplifier.

FIG. 4 is a graph for explaining the effects of the embodiment of the optical disc apparatus and adjustment method of the present invention.

FIG. 5 is a structural diagram for explaining another embodiment of the optical disc apparatus and adjusting method of the present invention.

FIG. 6 is a structural diagram for explaining the other embodiment of the optical disc apparatus and adjusting method of the present invention.

FIG. 7 is a structural diagram for explaining the other embodiment of the adjusting device and method of the optical disc apparatus of the present invention.

FIGS. 8(a), 8(b), 8(c) are graphs for explaining distortion of waveform due to the group delay distortion.

FIGS. 9(a), 9(b) are diagrams for explaining the inter-symbol interference due to coma.

### DETAILED DESCRIPTION OF THE PREFERRED EMBODIMENTS

The optical disc apparatus and adjusting method and device of the optical disc apparatus of the present invention will be explained in detail with reference to the preferred embodiments of the present invention.

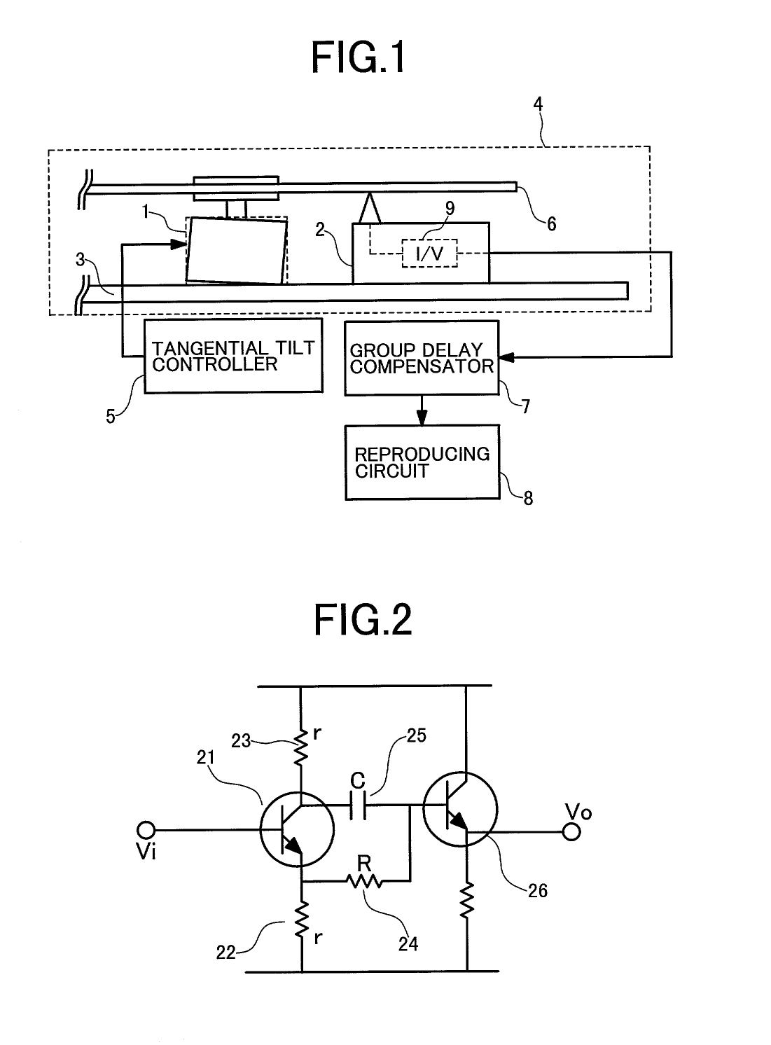

A preferred embodiment of an optical disc apparatus where the present invention is applied to a DVD-ROM (Digital Versatile Disc-Read Only Memory) device is illustrated in FIG. 1. In FIG. 1, the reference numeral 1 designates a spindle motor for rotating a disc 6; 2, an optical head for executing recording and reproduction of signal by irradiating the disc 6 with an optical spot; 3, a base for fixing the spindle motor 1 and optical head 2; 4, an optical head assembly including the spindle motor 1, optical head 2 and base 3; 5, a tangential tilt controller for fine adjustment of tilt of the spindle motor 1 in the tangential direction; 7, a group delay compensator for compensating the group delay or the like of the reproduced signal from the optical head 2; 8, a reproducing circuit for executing data decision or the like by inputting an output signal of the group delay compensator.

The optical head 2 also comprises a current-voltage amplifier (I/V) 9 for converting an output current of the optical detector to a voltage, in addition to the optical elements (not illustrated) such as laser beam source, objective lens and optical detector or the like. Here, the optical head 2 is driven with a driving mechanism to move in the radial direction of the disc 6 but this mechanism is omitted from illustration.

The tangential tilt controller 5 employs a mechanism that a tilt is given by adjusting vertical height from the base 3 depending on rotation of a screw by defining one end for fixing the spindle motor 2 for the base 3 as the fulcrum and one end of stopper screw in the opposite direction as the working point.

Next, a structure of the group delay compensator 7 is illustrated in FIG. 2. The reproduced signal from the optical head 2 becomes an input signal Vi to the base of a transistor 21 and the signal of the same phase as the input signal Vi is outputted to the emitter of transistor 21, while the signal in the inverse phase of the input signal Vi and in the same amplitude as the emitter signal is outputted to the collector. Here, the emitter resistor 22 and collector resistor 23 have the identical resistance value. These signals are added in the transistor 26 and are then outputted as the output signal Vo after passing the resistor 24 of resistance value R and the capacitor 25 of capacitance value C.

The input/output transfer function of this circuit is expressed as

Vo/Vi=(1−j2πfCR)/(1+j2πfCR)

where f is frequency and j is imaginary number.

Since a group delay is expressed as 2 CR/(1+(2 πfCR)²), having the characteristic that it becomes 2 CR at DC and is reduced to zero when the frequency becomes high.

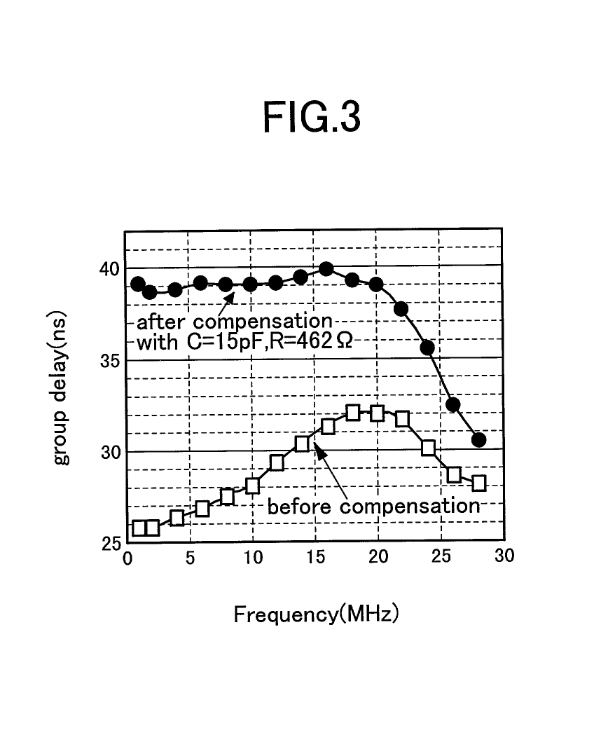

On the other hand, the current-voltage amplifier 9 generally has the characteristic that the group delay becomes larger in the higher frequency band, for example, as indicated with the lower side curve in FIG. 3. Therefore, this characteristic can be compensated by adequately selecting the resistance value R of resistor 24 and capacitance value C of the capacitor 25 of the group delay compensator 7 of FIG. 2. An example of compensation result is indicated with the upper side curve in FIG. 3. In this example, deviation of group delay can be reduced to 1 nsec or less for the frequency up to 20 MHz by giving the condition of C=15 pF and R=462 Ω. Here, a group delay difference of group delay characteristic of the group delay compensator 7 between the DC and the upper limit of the frequency to be processed is defined as the group delay compensation amount. As the practical setting method of the group delay compensation amount, the resistance value R of the resistor 24 is selected by fixing, for example, the capacitor 25 to C=15 pF and then switching a plurality of resistors with a switch.

The power supply, electrical circuit substrate and various mechanisms not explained above are assembled in addition to the mechanisms and circuits explained above in order to complete an optical disc apparatus.

Next, adjustment of the optical disc apparatus will be explained. When a disc 6 is set to the optical disc apparatus, reproduction of data starts after a series of the initial operation. The reproduced data can be obtained through the optical head 1, current-voltage amplifier 9, group delay compensator 7 and reproducing circuit 8. Adjustment of the optical disc apparatus is performed with adjustment of the group delay compensation amount and tilt amount to minimize the error by counting the number of errors in this reproduced data.

In more practical, the error is measured by changing the group delay compensation amount while the tangential tilt is changed little by little. Errors are measured for various tilts and the amounts of tilt and group delay compensation to provide the minimum error are obtained. Adjustment of the optical disc apparatus is completed by fixing the tangential tilt controller 5 and group delay compensator 7 to such values. When this adjustment is conducted for each data reproduction, adjustment of the optical disc apparatus including the disc 6 can be executed. Moreover, using a reference disc, adjustment of the optical disc apparatus can be executed by fixing the tangential tilt controller 5 and group delay compensator 7 to the optimum adjustment result and then eliminating the adjustment for each reproduction of disc.

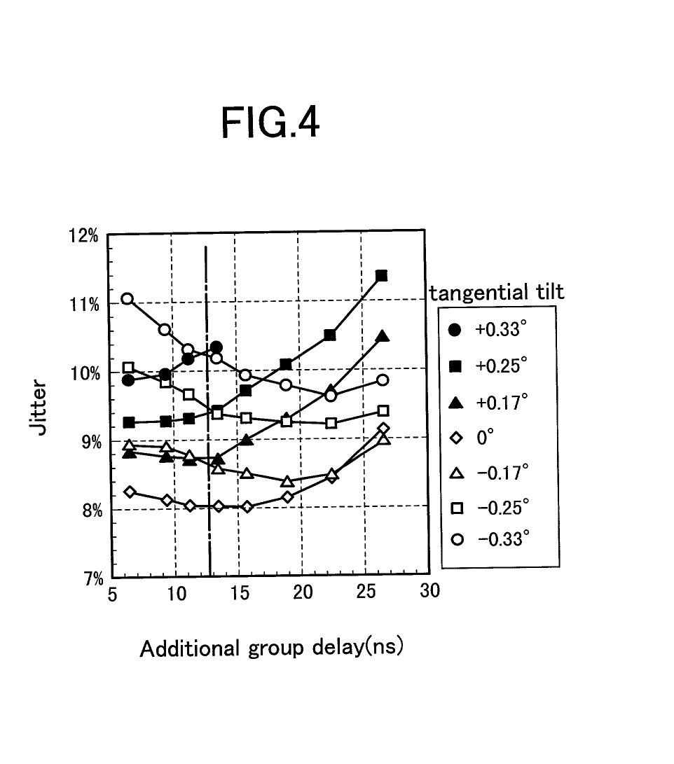

The adjustment can also be performed by minimizing the error and moreover minimizing jitter in the reproduced data and the identical effects can also be attained. An example of result of the adjustment conducted for this jitter will be illustrated in FIG. 4. The lateral axis of FIG. 4 indicates the amount of group delay compensation, while the vertical axis, amplitude of jitter. Jitter has been measured by changing group delay compensation while the tangential tilt is changed between +0.33° to −0.33°. Here, the tilt of 0° is the condition that the mechanical tilt is not zero and the minimum jitter can be obtained. In the optical head 2, the wavelength of laser of the laser source is 650 nanometer and NA of the objective lens is 0.6. The reference deviation of the detection edge after operation of PLL (Phase Locked Loop) under the condition that the reproducing speed is about 17 nsec at the detection window width and waveform equalization condition is optimized in the reproducing circuit has been defined as jitter.

The minimum jitter of 8% has been obtained under the condition that the tangential tilt is zero and group delay compensation amount is 12 nsec. The group delay of 12 nsec is equal to the group delay of the transmitter as a whole in the tilt other than the optical tilt. When the group delay is set to 12 nsec, the jitter curve for the tilt in the ± directions becomes symmetrical and therefore the maximum jitter margin can be obtained.

As explained above, since the condition for minimizing error or jitter is determined with the tilt adjustment and group delay compensation, erroneous compensation for adjusting the group delay distortion of the electrical transmitter with tilt can be prevented. Moreover, since such condition has been obtained, it is proved that distortion of waveform in the optical/electrical transmitter channel as a whole can be minimized.

Even in the optical head 2, coma (aberration) is generated in some cases in the optical beam due to the distortion of optical elements such as light source and objective lens or the like provided therein. This coma also generates distortion, in the reproduced signal, of waveform that is similar to that resulting from phase characteristic of the electric circuit channel. Therefore, in the compensation with the group delay compensator 7, group delay and this distortion of waveform are simultaneously compensated.

Here, since tilt is generated due to the relative relationship between the inclination of disc 6 and optical axis for the disc 6 of the optical head 2, tilt adjustment can be realized by adjusting the tilt of optical head 2 in place of adjustment of tilt of the spindle motor 1 and thereby changing inclination of optical axis. Moreover, since the inclination of optical axis changes when inclination of the objective lens is changed, the tilt adjustment can also be realized with adjustment of inclination of the objective lens. Adjustment for inclination of the objective lens can be executed, for example, by supporting a lens with an actuator and then changing movement of the actuator.

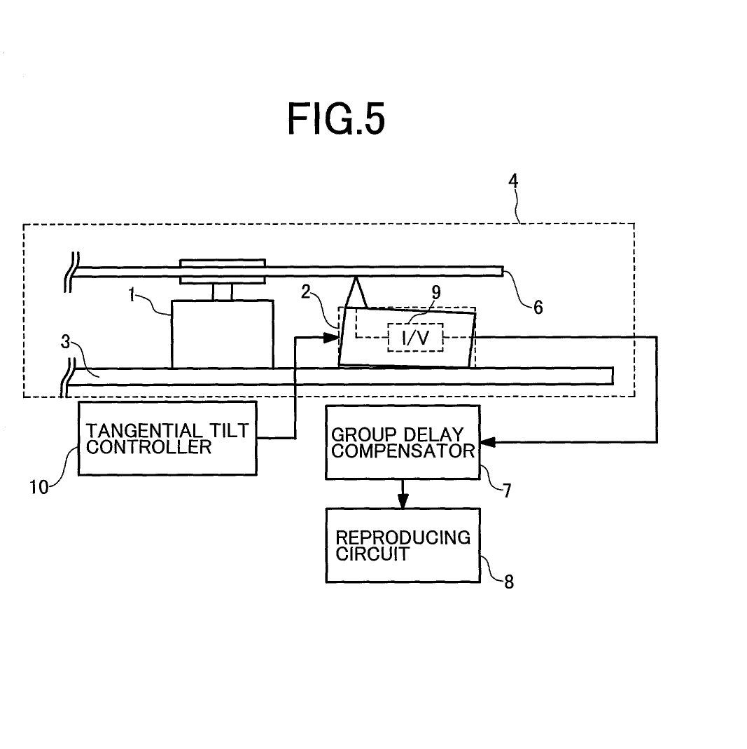

Another embodiment of the optical disc introducing a mechanism for adjusting tilt of optical head 2 is illustrated in FIG. 5. Adjustment with the tangential tilt controller 10 can be realized, for example, by preparing an optical head base (not illustrated) for fixing the optical head 2 and changing, with a screw, the inclination of the optical head 2 for the optical head base as in the case of the tangential tilt controller 5 in FIG. 1. Even in the case of this embodiment of the present invention, adjustment is performed to attain the minimum error or jitter with the tilt adjustment and group delay compensation.

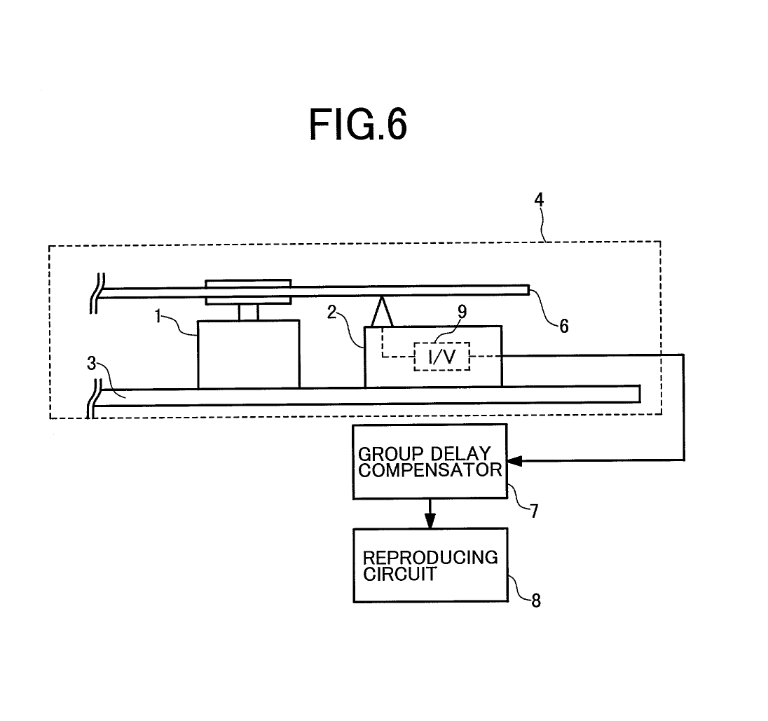

It has been explained above that the phase characteristic and waveform distortion of the reproduced signal when the tangential tilt exists are similar to that when phase distortion exists in the electrical circuit channel. Therefore, it is now possible to compensate the distortion of waveform of the reproduced signal when the tangential tilt exists only with the group delay compensator without use of the tangential tilt controller 5, although compensation is limited to that for tilt adjustment. The other embodiment of the optical disc apparatus having introduced such structure is illustrated in FIG. 6. In this case, the phase characteristic depending on the tilt and the phase characteristic of the current-voltage amplifier 9 are compensated, in common, simultaneously. Moreover, when there exists coma due to distortion of optical elements in the optical head 2, distortion of waveform due to the coma is also compensated. Even in this embodiment of the present invention, adjustment is conducted with the group delay compensation to provide minimum error or jitter.

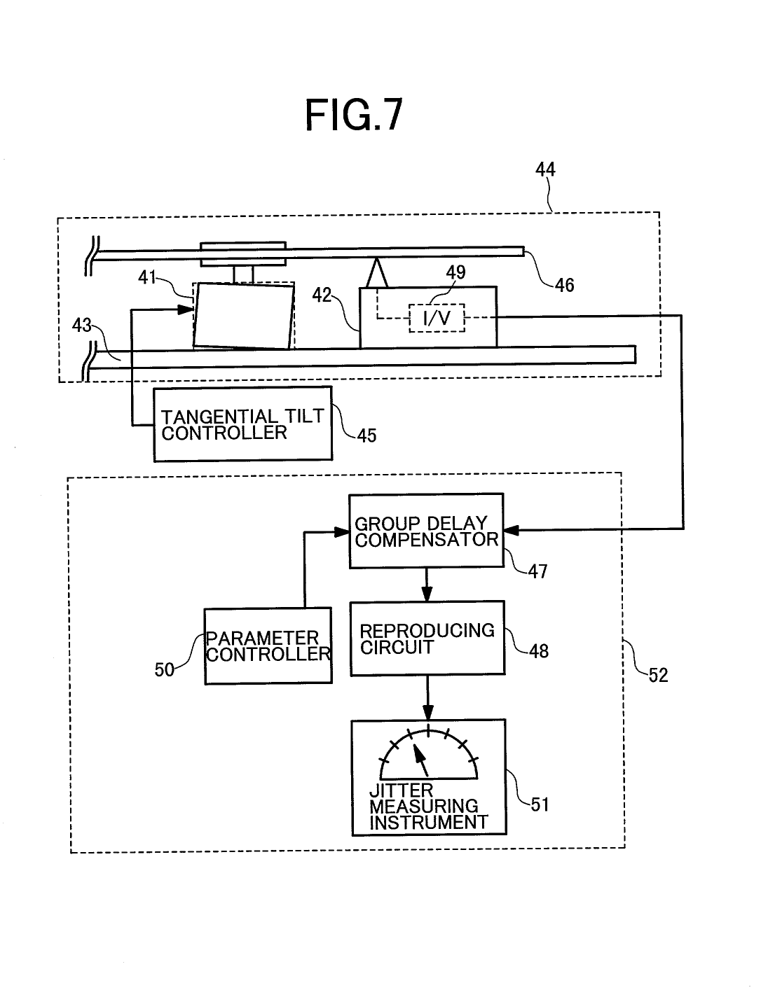

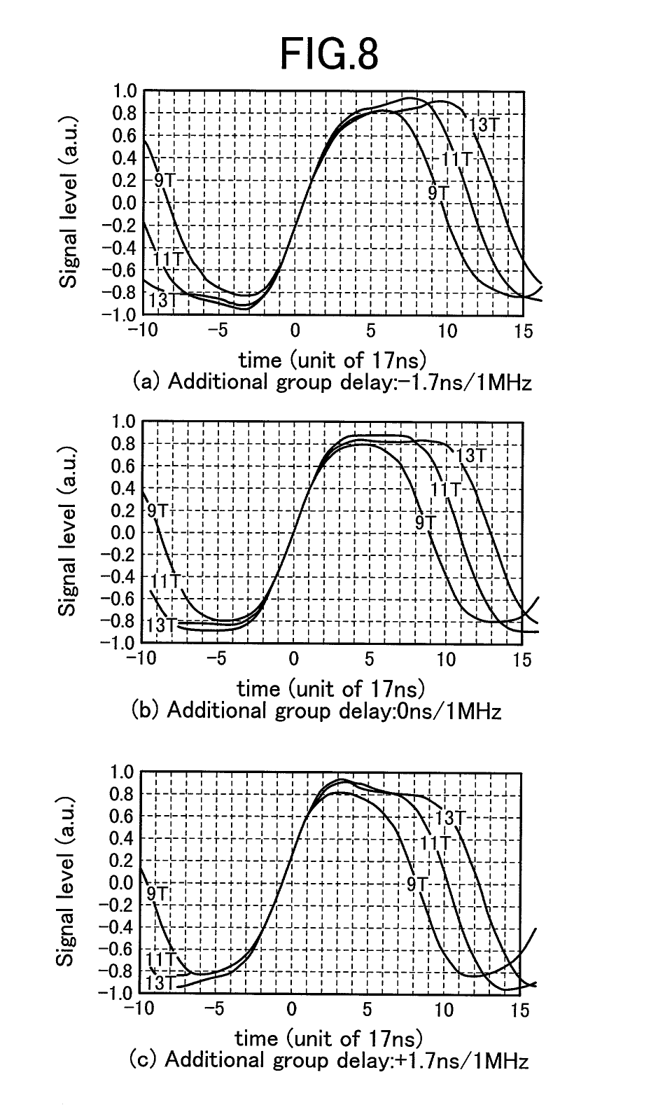

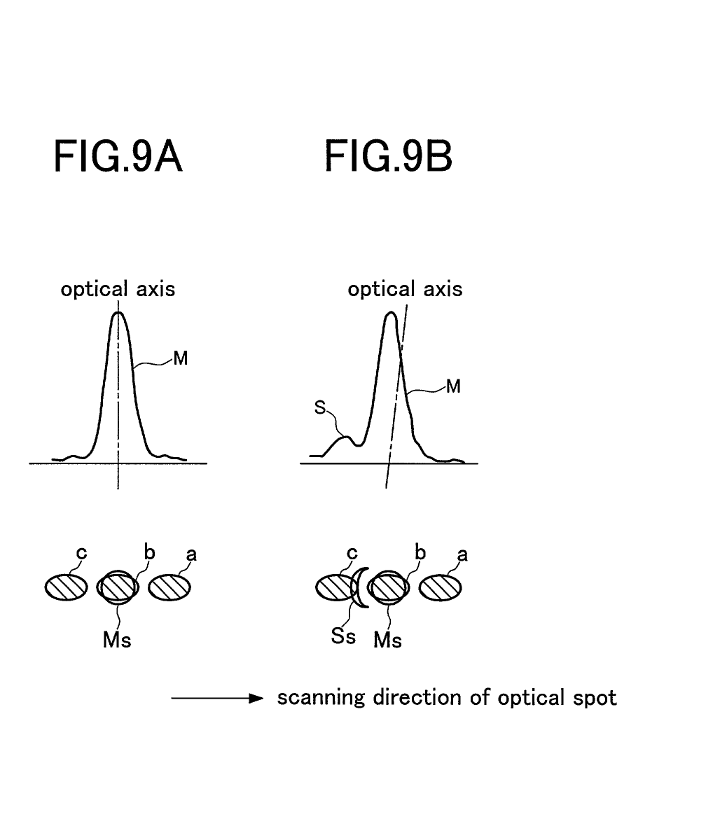

Next, the embodiment of the present invention of the adjusting apparatus using the principle of the tilt adjustment explained above used in the manufacturing process of optical disc apparatus is illustrated in FIG. 7. The optical head assembly 44 including the base 43 fixing the spindle motor 41 and optical head 42 is an object of the adjustment. The tangential tilt controller 45 is identical to the controller 5. After the adjustment, the power supply, electrical circuit substrate and various mechanisms not illustrated are further assembled to form the optical disc apparatus.

The controller 52 comprises a group delay compensator 47, a reproducing circuit 48, a parameter controller 50 for setting additional delay compensation of the group delay compensator 47 and a jitter measuring instrument 51 for displaying jitter of the reproduced data outputted from the reproducing circuit 48. The group delay compensator 47 and reproducing circuit 48 are requested to provide an average fluctuation of characteristics in the circuit used for the optical disc apparatus.

For the adjustment, a disc 56 where the bit pattern of the DVD-ROM device is recorded on a glass substrate having excellent flatness is used as the reference disc.

The actual adjustment procedures for disc tilt will then be explained. Additional compensation of the group delay compensator 57 is set to the initial value with the parameter controller 60. As the initial value, the typical value that may be estimated in the stage of design is selected. Under this condition, the disc 46 is given a tilt by rotating a screw of the tilt controller 55 with a tilt setter 51 to set the tilt for resulting in the minimal jitter on the display of the jitter measuring instrument 59. Next, while change of jitter value is observed by changing the additional group delay compensation, the group delay compensating condition for attaining the minimal jitter is found. Subsequently, whether the jitter value is minimum or not is confirmed by changing again the tilt. When the minimum jitter is attained, tilt adjustment is completed. If jitter is further reduced, the tilt resulting in minimum jitter is attained again and subsequently the group delay compensation condition to provide the minimal jitter is detected. With repetition of the procedures explained above, the condition for minimizing the jitter is obtained. When the adjustment is completed, a screw for tilt adjustment is fixed. The value of additional group delay compensation obtained with the adjustment is used as the initial value of the additional group delay compensation of the group delay compensator 7.

According to the present invention, the condition to provide minimum error or jitter can be obtained through the tilt adjustment and group delay compensation. Therefore, erroneous compensation of tilt can be prevented and waveform distortion of the optical/electrical transmitter as a whole can be minimized. Moreover, jitter margin of the optical disc apparatus can also be enhanced and an optical disc apparatus of higher reliability can also be provided. In addition, even in the case of obtaining the condition to minimize error or jitter through adjustment of only the group delay compensation, waveform distortion of the optical/electrical transmission channel as a whole can be alleviated.

It is further understood by those skilled in the art that the foregoing description is a preferred embodiment of the disclosed device and that various changes and modifications may be made in the invention without departing from the spirit and scope thereof.

What is claimed is:

1. An optical disc apparatus, comprising:
means for rotating an optical disc,
means for outputting a reproduced signal by irradiating an optical disc having information track in which information is recorded with an optical spot,
group delay compensating means for compensating group delay for the reproduced signal, and
means for adjusting a relative angle in the information track direction between the optical disc and optical axis of the optical beam.

2. An optical disc apparatus, comprising
means for rotating an optical disc,
means for outputting a reproduced signal by irradiating the optical disc having information track to which information is recorded with an optical spot, and
group delay compensating means for compensating group delay for the reproduced signal.

3. An optical disc apparatus according to claim 1, further comprising a reproducing circuit for executing data reproducing process by inputting a signal after group delay compensation outputted from said group delay compensating means.

4. An optical disc apparatus according to claim 2, further comprising a reproducing circuit for executing data reproducing process by inputting a signal after group delay compensation outputted from said group delay compensating means.

5. An optical disc apparatus according to claim 2, wherein said group delay compensating means executes compensation of group delay for the reproduced signal including distortion of waveform generated with an optical spot including coma.

6. An optical disc apparatus, comprising:
a spindle motor for rotating an optical disc,
an optical head for outputting a reproduced signal by irradiating an optical disc having information track to which information is recorded with an optical spot,
a group delay compensator for compensating group delay for the reproduced signal, and
a tangential tilt controller for adjusting a tilt of said spindle motor by changing a relative angle in the information track direction between the optical disc and optical axis of optical beam.

7. An optical disc apparatus, comprising:
a spindle motor for rotating an optical disc,
an optical head for outputting a reproduced signal by irradiating an optical disc having information track to which information is recorded with an optical spot,
a group delay compensator for executing group delay compensation to the reproduced signal, and
a tangential tilt controller for adjusting a tilt of an optical head in the direction of information track of the optical disc.

8. An optical disc apparatus according to claim 6, further comprising a reproducing circuit for executing data reproducing process by inputting a signal after group delay compensation outputted from said group delay compensator.

9. An optical disc apparatus according to claim 7, further comprising a reproducing circuit for executing data reproducing process by inputting a signal after group delay compensation outputted from said group delay compensator.
